(19) United States
(12) Patent Application Publication
(10) Pub. No.: US 2006/0207359 A1
(43) Pub. Date: Sep. 21, 2006

(54) Compact linear/rotary actuator for offset actuation

(76) Inventor: Keith Kowalski, Bethlehem, CT (US)

Correspondence Address: JOHN H CROZIER, 1934 HUNTINGTON TURNPIKE, TRUMBULL, CT, 06611, US

(21) Appl. No.: 11/136,990

(22) Filed: May 25, 2005

Related U.S. Application Data
(60) Provisional application No. 60/575,356, filed on May 28, 2004.

(51) Int. Cl. F16H 27/02

(52) U.S. Cl. 74/89.23

(57) ABSTRACT

In a preferred embodiment, an apparatus, comprising: a rotary motor having an external shaft with an axial slot defined therethrough; a linear motor having a threaded external shaft with a translating nut disposed thereon; and the threaded external shaft being disposed in the slotted external shaft, with a tab on the translating nut extending through the axial slot, the tab preventing the translating nut from rotational motion.

### CROSS-REFERENCE TO RELATED APPLICATION

The present application claims the benefit of the filing date of U.S. Provisional Application No. 60/575,356, filed May 28, 2004, and titled COMPACT LINEAR/ROTARY ACTUATOR FOR OFFSET ACTUATION.

### BACKGROUND OF THE INVENTION

1. Field of the Invention

The present invention relates to actuators generally, and more particularly, but not by way of limitation, to a novel compact linear/rotary actuator for offset actuation.

2. Background Art

There are times when it is desirable to have a single actuator provide both linear and rotary motion. Applications for such an actuator are pick-and-place or sampling.

There are many existing methods to accomplish this type of motion; however, many are mechanically complicated or require a length which is often more than two times the actual stroke required.

Many designs also cannot properly handle offset axial loads without excessive deflections. Several of these designs also include an intermediate coupling that is often complicated to manufacture. The coupling can often add hysterisis to the system as well.

Accordingly, it is a principal object of the present invention to provide a compact linear/rotary actuator that has a linear stroke that is approximately one-half of the overall package size, compared with conventional linear/rotary actuators.

It is a further object of the invention to provide such a compact linear/rotary actuator that is mechanically simple.

It is an additional object of the invention to provide such a compact linear/rotary actuator that can effectively support offset axial loads.

It is another object of the invention to provide such a compact linear/rotary actuator that can be economically manufactured.

Other objects of the present invention, as well as particular features, elements, and advantages thereof, will be elucidated in, or be apparent from, the following description and the accompanying drawing figures.

### SUMMARY OF THE INVENTION

The present invention achieves that above objects, among others, by providing in a preferred embodiment, an apparatus, comprising: a rotary motor having an external shaft with an axial slot defined therethrough; a linear motor having a threaded external shaft with a translating nut disposed thereon; and said threaded external shaft being disposed in said slotted external shaft, with a tab on said translating nut extending through said axial slot, said tab preventing said translating nut from rotational motion.

### BRIEF DESCRIPTION OF THE DRAWING

Understanding of the present invention and the various aspects thereof will be facilitated by reference to the accompanying drawing figures, provided for purposes of illustration only and not intended to define the scope of the invention, on which:

FIG. 1 is a side elevational view of the linear portion of the linear/rotary actuator of the present invention.

FIG. 2 is a side elevational view of the rotary portion of the linear/rotary actuator of the present invention.

FIG. 3 is a side elevational view of a combined linear/rotary actuator of the present invention.

FIG. 4 is a fragmentary, side elevational view of a bearing support at the distal end of the leadscrew of the present invention.

FIG. 5 is a side elevational view showing a common housing for the linear and rotary motors of the present invention.

FIG. 6 is a top plan view showing how samples can be arranged radially around the linear/rotary actuator of the present invention.

### DETAILED DESCRIPTION OF THE PREFERRED EMBODIMENTS

Reference should now be made to the drawing figures on which similar or identical elements are given consistent identifying numerals throughout the various figures thereof, and on which parenthetical references to figure numbers, when used, direct the reader to the view(s) on which the element(s) being described is (are) best seen, although the element(s) may be seen on other figures also.

The linear/rotary actuator comprises two motors: one to provide the linear motion and one to provide the rotary motion.

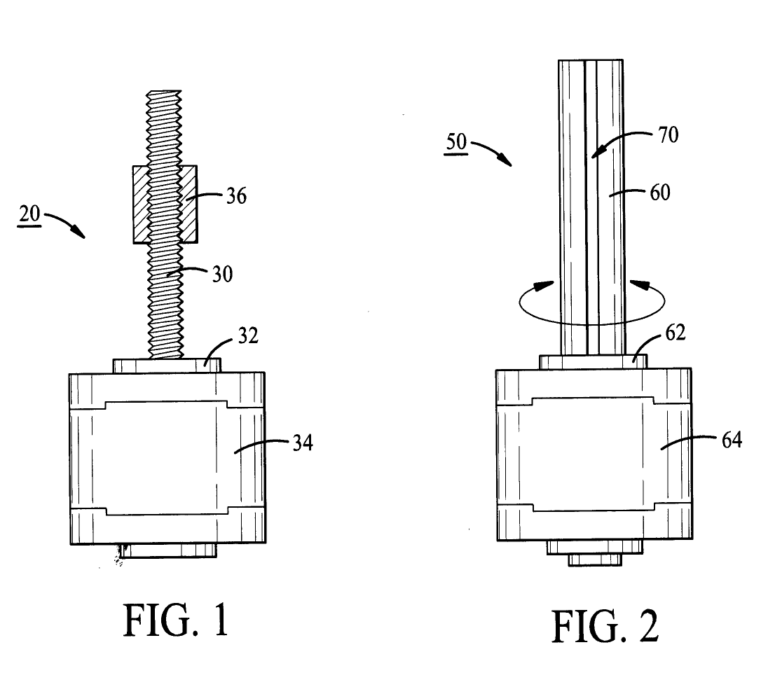

Referring first to FIG. 1, which illustrates the linear motor portion 20 of the present invention, constructed according to the present invention and generally indicated by the reference numeral 20. Linear motor portion 20 of the linear/rotary actuator is of the “external linear” design in that a threaded screw 30 is fixed to a rotor 32 (reference the double headed arrow shown on FIG. 1) in motor 34 and a translating nut 36 is installed on the threaded screw. As in conventional external linear actuators, nut 36 must be prevented from turning on the threaded screw 30 to provide linear motion as the threaded screw selectively turns in the directions indicated by the double headed arrow on FIG. 1.

Referring now to FIG. 2, there is illustrated the rotary motor portion of the linear/rotary actuator, constructed according to the present invention, and generally indicated by the reference numeral 50. Rotary motor portion 50 includes a hollow shaft 60 attached to a rotor 62 (reference the double headed arrow shown on FIG. 2) in motor 64. Shaft 60 must extend through motor 64 and has an axially slot 70 defined along the external portion of the shaft.

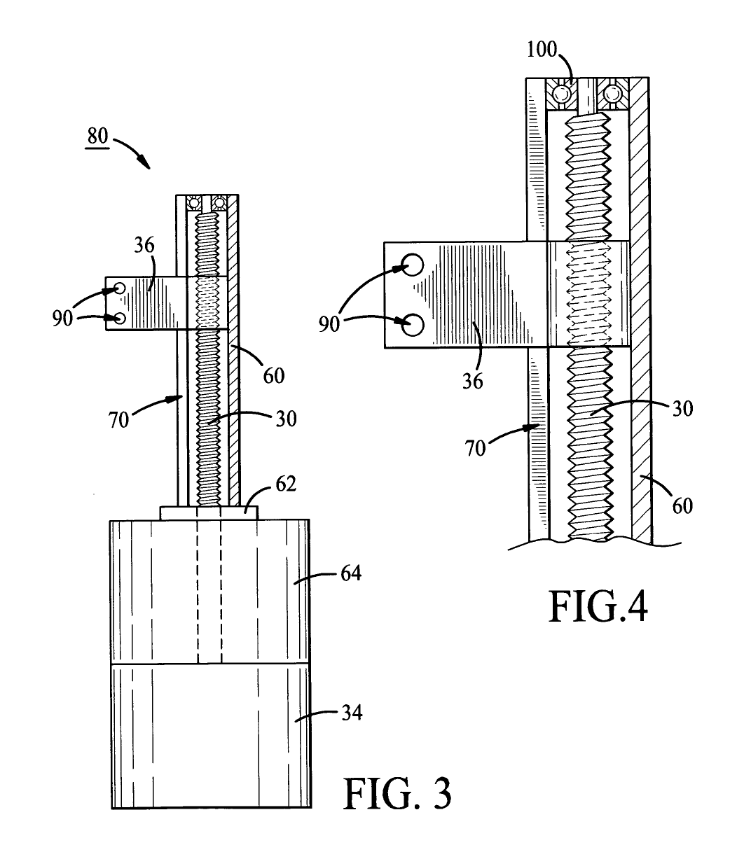

FIG. 3 illustrates the combined actuator, generally indicated by the reference numeral 80, and illustrates that threaded screw 30 (FIG. 1) is inserted in slotted shaft 60. Translating nut 36 extends through slot 70, which keeps the translating nut from turning. The distal end of translating nut 36 is shown as having two vertically aligned holes 90 for attachment thereof of other apparatus, but any type of means of attachment to other apparatus may be provided as well.

FIG. 4 illustrates that the distal end of threaded screw 30 is journaled in a bearing 100 fixed in the distal end of slotted shaft 60, but such may not be required depending on the degree of travel.

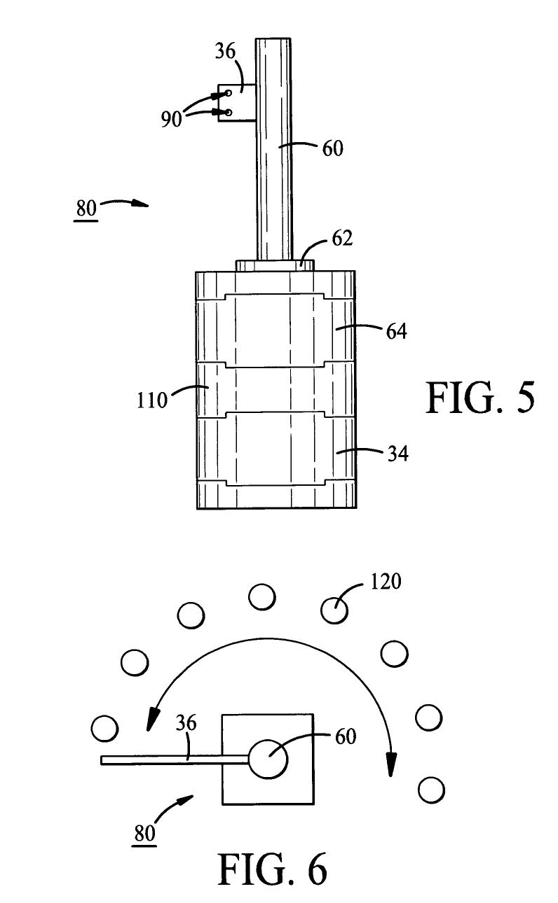

FIG. 5 illustrates that the design may be further simplified by providing a common interface (housing) 110 between motors 34 and 64. This can lower cost and provide better alignment.

The operation of linear/rotary actuator 80 (FIG. 3) is as follows:

For linear motion: motor 64 is locked and motor 34 is run, causing translating nut to 36 to traverse axially. Translating nut 36 is prevented from rotating by a tab extending axially through slot 70. Radial support and resistance to moments caused by the offset loading are provided by the fit of the outside of translating nut inside slotted shaft 60.

For rotary motion: both motors 64 and 34 are rotated simultaneously. Since both motors are rotating together, there is no relative motion between the translating nut 36 and threaded screw 30 and pure rotary motion results.

Helical motion can be accomplished by rotating motors 64 and 34 at different speeds or by rotating rotary motor 64 and locking linear motor 34.

Linear/rotary actuator 80 (FIG. 3) is especially suited for laboratory automation where samples must be withdrawn and dispensed from many locations. This is illustrated on FIG. 6 where samples, as at 120, are arranged radially around linear/rotary actuator. In this case, an arm carrying a sampling device is attached to translating nut 36 and samples 120 can be added to or dispensed by the up-and-down and rotary motion of linear/rotary actuator 80.

In the embodiments of the present invention described above, it will be recognized that individual elements and/or features thereof are not necessarily limited to a particular embodiment but, where applicable, are interchangeable and can be used in any selected embodiment even though such may not be specifically shown.

Spatially orienting terms such as “above”, “below”, “upper”, “lower”, “inner”, “outer”, “inwardly”, “outwardly”, “vertical”, “horizontal”, and the like, when used herein, refer to the positions of the respective elements shown on the accompanying drawing figures and the present invention is not necessarily limited to such positions.

It will thus be seen that the objects set forth above, among those elucidated in, or made apparent from, the preceding description, are efficiently attained and, since certain changes may be made in the above construction without departing from the scope of the invention, it is intended that all matter contained in the above description or shown on the accompanying drawing figures shall be interpreted as illustrative only and not in a limiting sense.

It is also to be understood that the following claims are intended to cover all of the generic and specific features of the invention herein described and all statements of the scope of the invention which, as a matter of language, might be said to fall therebetween.

The embodiments of the invention in which an exclusive property or privilege is claimed are defined as follows:

1. An apparatus, comprising:
(a) a rotary motor having an external shaft with an axial slot defined therethrough;
(b) a linear motor having a threaded external shaft with a translating nut disposed thereon; and
(c) said threaded external shaft being disposed in said slotted external shaft, with a tab on said translating nut extending through said axial slot, said tab preventing said translating nut from rotational motion.

2. An apparatus, as defined in claim 1, further comprising: a distal end of said threaded external shaft is journaled in a bearing fixed in a distal end of said external shaft of said rotary motor.

3. An apparatus, as defined in claim 1, wherein: said rotary motor and said linear motor are disposed in a common housing.

4. An apparatus, as defined in claim 1, wherein: radial support and resistance to moments caused by offset loading are provided by fit of an outside of said translating nut inside said external shaft of said rotary motor.
